(19) United States
(12) Patent Application Publication
(10) Pub. No.: US 2026/0257161 A1
(43) Pub. Date: Sep. 3, 2026

(54) SEPARATOR FOR A FLUID CLEANING DEVICE

(71) Applicant: Dyson Technology Limited, Malmesbury, Wiltshire (GB)

(72) Inventor: Mateusz GUGALA, Gloucester (GB)

(21) Appl. No.: 19/165,249

(22) PCT Filed: Mar. 4, 2024
(86) PCT No.: PCT/IB2024/052071

§ 371 Date: Sep. 15, 2025

(30) Foreign Application Priority Data
Mar. 31, 2023 (GB) 2304810. I

(51) Int. Cl. B01D 46/00; B01D 46/10

(52) U.S. Cl. CPC B01D 46/0049; B01D 46/0002; B01D 46/0042; B01D 46/103

(57) ABSTRACT

A separator for a fluid cleaning device including a separating volume, an inlet through which a fluid flow containing entrained debris flows into the separating volume while in use, an outlet through which a filtered fluid flow is discharged from the separator while in use, a filter screen to retain the debris in the separating volume while allowing fluid to exit the separating volume to form the filtered fluid flow, an outlet volume disposed between the separating volume and the outlet, and a partition wall that partitions the outlet volume into a high pressure zone and a low pressure zone. The outlet volume receives the filtered fluid flow from the separating volume through the filter screen. The partition wall defines first and second openings into the low pressure zone from the high pressure zone. The first and second openings are at different distances from the outlet.

### BACKGROUND

Many fluid cleaning devices implement a primary separator, for example a cyclonic separator, as an initial stage of purification. The primary separator acts to remove the heaviest particles and/or debris from an incoming fluid flow. In the case of vacuum cleaning devices, a separator may replace a dust bag, in that the separator can be configured to remove and collect larger particulates and debris from an incoming flow of air. This creates a partially filtered flow, which may then be purified further by a fine dust separator and optionally additional filters such as a HEPA (high efficiency particulate air) filter, such that particulates of successively smaller sizes are removed from the flow to produce a purified output. When the separator is full it can be removed, emptied and returned to the device.

Various separator configurations are known, but typically a separator comprises a hollow housing assembly that encloses an internal volume that is divided into two mutually separated chambers by a separating grid, which is also referred to as a ‘shroud’ or ‘mesh’. The mesh acts as a filter screen that allows fluid and particles below a certain size to pass between the chambers, whilst blocking larger particles and debris. Incoming air containing debris is delivered into a first of these chambers, which is therefore an upstream chamber that may be referred to as the ‘primary bin’. The second, downstream chamber on the opposite side of the mesh, or ‘secondary bin’, which may be in the form of a duct, is connected to an outlet of the separator through which the partially filtered flow is expelled.

Over time, the mesh may become progressively blocked by debris and particles that attach to, or otherwise accumulate on, the surface of the mesh, which may be referred to as blinding of the mesh. Blinding of the mesh increases resistance to air flow through the mesh and so reduces separation efficiency. This, in turn, hinders the performance of the device until the mesh is cleaned. This potentially necessitates a user intervention before the primary bin is full, which increases the level of user maintenance required.

It is against this background that the present invention has been devised.

### SUMMARY

An aspect of the invention provides a separator for a fluid cleaning device. The separator comprises: a separating volume; an inlet through which a fluid flow containing entrained debris flows into the separating volume, in use; an outlet through which a filtered fluid flow is discharged from the separator, in use; a filter screen, which may define at least part of a boundary of the separating volume, the filter screen being configured to retain the debris in the separating volume while allowing fluid to exit the separating volume to form the filtered fluid flow; an outlet volume disposed between the separating volume and the outlet, the outlet volume being configured to receive the filtered fluid flow from the separating volume through the filter screen; and a partition wall that partitions the outlet volume into a high pressure zone and a low pressure zone. The partition wall defines first and second openings into the low pressure zone from the high pressure zone, the first and second openings being at different distances from the outlet.

The high pressure zone may be a zone of the outlet volume that is directly adjacent to, or bounded by, at least part of the filter screen. For example, a downstream side of the filter screen may define part of a boundary of the high pressure zone. The low pressure zone may be adjacent to, or may include, the outlet.

The first and second openings may each communicate directly with the outlet through the low pressure zone, and so may both be at relatively low pressure, and potentially at similar or equal pressure to one another. Meanwhile, higher pressure arising from the flow through the filter screen may be substantially contained by the partition wall in the high pressure zone. In this way, low pressure at the outlet may be translated to the first and second openings due to a shielding effect provided by the partition wall. In turn, positioning the first and second openings at different distances from the outlet entails that the translated low pressure delivers suction to areas adjacent to correspondingly spaced portions of the filter screen. Thus, suction may be distributed over the filter screen to balance flow through the filter screen from the separating volume. This may in turn reduce localised blinding of the filter screen.

The partition wall may define more than two openings between the high and low pressure zones, some or all of which may be at different distances from the outlet.

The partition wall may extend parallel to the filter screen.

The partition wall may define an open-ended enclosed passage defining the high pressure zone. The filter screen may define part of a boundary of the passage. The first and second openings may be disposed at opposed ends of the passage. The passage may have a uniform cross-section along its length.

The separator may comprise multiple partition walls, which may define multiple high pressure zones. The partition walls may be staggered, for example, and may define a series of openings between the high and low pressure zones that are at varying distances from the outlet.

At least one of the first and second openings may be defined between the partition wall and another wall of the separator, for example a wall of the separating volume, which wall may comprise or support the filter screen.

At least one of the first and second openings may be formed in the partition wall. For example, the partition wall may be perforated. The partition wall may comprise the first opening and the second opening, the second opening being further from the outlet than the first opening. The second opening may be larger than the first opening.

The first opening may be disposed between the second opening and the outlet, in the sense that the spatial positioning of the first opening, the second opening and the outlet is such that the first opening is between the second opening and the outlet. For example, a straight line drawn between the second opening and the outlet may intersect the first opening.

The filter screen may be curved, for example U-shaped, or the filter screen may be generally planar, for example. The filter screen may be shaped to conform to a wall of the separator in or on which the filter screen is installed or supported.

A cross section of the partition wall may define a closed loop so that the partition wall forms a tube or channel. The separator may comprise multiple such partition walls defining tubes. The tubes may have an oval or otherwise non-circular cross section.

The inlet and the outlet may be spaced along a longitudinal axis of the separator. The inlet and the outlet may be disposed at opposed longitudinal ends of the separator.

The filter screen may extend parallel to a longitudinal axis of the separator.

The separator may comprise multiple filter screens through which fluid flows from the separating volume into the outlet volume.

The inlet optionally defines an inlet axis that is parallel to a longitudinal axis of the housing. The outlet optionally defines an outlet axis that is parallel to a longitudinal axis of the housing.

The separator may comprise a housing that contains the separating volume and the outlet volume. The housing may be formed from multiple parts.

The invention also extends to a cleaning device comprising the separator of any preceding claim. The device may be embodied as a domestic appliance, for example.

Another aspect of the invention provides a method of configuring a separator for a fluid cleaning device. The method comprises partitioning an outlet volume of the separator into a high pressure zone and a low pressure zone, so that first and second openings into the low pressure zone from the high pressure zone are at different distances from an outlet of the separator. The separator may comprise: a separating volume; an inlet through which a fluid flow containing entrained debris flows into the separating volume, in use; an outlet through which a filtered fluid flow is discharged from the separator, in use; a filter screen, which may define at least part of a boundary of the separating volume, the filter screen being configured to retain the debris in the separating volume while allowing fluid to exit the separating volume to form the filtered fluid flow; and an outlet volume disposed between the separating volume and the outlet, the outlet volume being configured to receive the filtered fluid flow from the separating volume through the filter screen. One or more partition walls may be used to partition the outlet volume.

Features described above in connection with each aspect of the invention are equally applicable to the other aspects of the invention.

### BRIEF DESCRIPTION OF THE DRAWINGS

FIG. 1 shows a schematic, cross-sectional view of an example of a separator for a fluid cleaning device;

FIG. 2 shows a schematic, cross-sectional view of a separator according to an embodiment of the invention for a fluid cleaning device;

FIG. 3 corresponds to FIG. 2 but shows a flow profile through a mesh of the separator;

FIG. 4 shows a schematic, cross-sectional view of a separator according to another embodiment of the invention for a fluid cleaning device, with a partition wall omitted;

FIG. 5 corresponds to FIG. 4 but includes the partition wall;

FIG. 6 shows a transverse cross-section corresponding to line A-A in FIG. 5;

FIG. 7 corresponds to FIG. 6 but shows an alternative partition wall configuration;

FIG. 8 corresponds to FIG. 6 but shows another alternative partition wall configuration;

FIG. 9 shows a schematic, cross-sectional view of a separator according to another embodiment of the invention for a fluid cleaning device; and

FIG. 10 shows a schematic, cross-sectional view of a separator according to another embodiment of the invention for a fluid cleaning device.

### DETAILED DESCRIPTION

In general terms, embodiments of the invention provide separators for fluid cleaning devices that are configured for reduced mesh blinding and a low pressure drop relative to known arrangements. The embodiments described below are configured for use in domestic vacuum cleaning devices, but it will be appreciated that other embodiments of the invention are applicable to a range of cleaning devices.

As air flows across a mesh of a separator, a portion of the flow passes through the mesh and the remainder flows tangentially across the mesh to recirculate within a separating volume, or ‘primary bin’. The flow passing through the mesh may be referred to as the ‘normal flow’, and the flow across the mesh may be referred to as the ‘tangential flow’. A ‘flow ratio’is then defined as the ratio of the normal flow to the tangential flow.

In known arrangements, the flow ratio may vary significantly across the surface of the mesh. If the ratio is particularly high in any part of the mesh, that is, the normal flow is high relative to the tangential flow, this may promote blinding of the mesh at that location.

Recognising this, embodiments of the invention achieve a reduction in mesh blinding through the use of a partition arrangement that manipulates suction that acts to pull a flow from a primary bin through a mesh and into a secondary bin, in particular to increase the normal flow in areas where it might ordinarily be low. In this way, the partition arrangement balances the flow ratio across the mesh so that the flow ratio becomes more uniform. In turn, localised mesh blinding due to a high flow ratio in a particular area of the mesh can be mitigated.

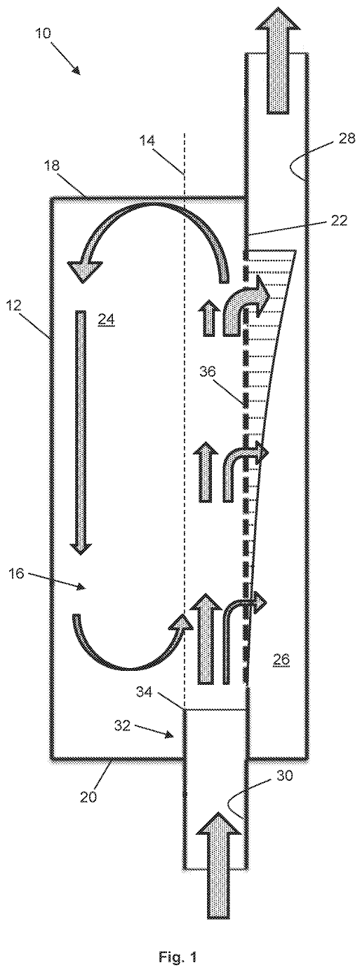

This is explained in more detail later. First, to provide context for the invention, FIG. 1 shows, in greatly simplified and schematic form, a separator 10 in which embodiments of the invention may be implemented. FIG. 1 is therefore used to describe the general layout of the separator, before moving on to consider embodiments of the invention that are shown in the later figures.

The separator 10 is configured for use in an environmental care device, or floorcare device, such as a vacuum cleaning device defining a domestic cleaning appliance. It is noted that embodiments of the invention may also be implemented in different types of device or separator, and more generally it is reiterated that the principles of the invention may be applied in a range of contexts. The separator 10 provides an initial stage of purification for the device by removing the largest particles and debris from an incoming fluid flow.

The separator 10 shown in FIG. 1 comprises a casing 12 defined by a tubular wall of circular cross section. The wall of the casing 12 encircles a central axis 14 to enclose a cylindrical interior volume 16, the central axis 14 also defining a central longitudinal axis of the separator 10. The casing 12 is configured for use with its central axis 14 oriented generally vertically as shown in FIG. 1, such that the casing 12 has an upper end and a lower end, the upper and lower ends being at opposed longitudinal ends of the casing 12. It is noted that casings of various shapes may be used in embodiments of the invention, however, including cuboidal casings for example.

The upper end of the casing 12 receives and is closed by an upper separator assembly, which is represented as an upper end plate 18 in the simplified view of FIG. 1. Correspondingly, the lower end of the casing 12 is closed by a lower separator assembly, which is represented as a lower end plate 20 in FIG. 1. The casing 12, the upper separator assembly and the lower separator assembly therefore collectively define a housing of the separator 10 that contains the interior volume 16.

A dividing wall 22 extends vertically from the lower end plate 20 to the upper end plate, to partition the interior volume of the casing 12 into two distinct volumes. The dividing wall 22 is curved in this example, although planar dividing walls may be used in other examples. The dividing wall 22 is positioned away from the central axis 14 of the casing 12, so that one of the volumes, shown to the left in FIG. 1, is significantly larger than the other volume. The larger volume defines a separating volume, or ‘primary bin’ 24, which occupies the majority of the volume 16 of the casing 12, while the smaller volume defines a secondary bin 26.

While the capacity of the primary bin 24 is significantly greater than that of the secondary bin 26 in this example, this may not be the case in other examples. In some examples, the primary bin and the secondary bin may be of similar volume. It is also possible for the secondary bin to have a greater volume than the primary bin.

In this example, the secondary bin 26 is in the general form of a duct that leads to an opening formed in the upper support plate 18. An open-ended tube defining an outlet duct 28 extends upwardly from this opening in the upper support plate 18. A central axis of the outlet duct 28 defines an outlet axis that is parallel to the central axis 14 of the separator 10. The secondary bin 26 is in fluid communication with the outlet duct 28. Indeed, the outlet duct 28 may be regarded as forming part of the secondary bin 26, to the extent that the outlet duct 28 is a continuation of the secondary bin 26.

When the separator 10 is in use in the device, a filtered air flow is discharged from the separator 10 through the outlet duct 28, such that the outlet duct 28 defines an outlet of the separator 10. The filtered flow discharged from the separator 10 is conveyed by suitable connections to additional purification stages within the device. For example, the outlet may deliver the flow to a cyclone pack that acts as a second purification stage of the device.

The lower end plate 20 is coupled to the casing 12 by a hinge (not shown) that enables the lower end plate 20 to pivot between an open position, in which the lower end plate 20 is disengaged from the casing 12, and a closed position, in which the lower end plate 20 engages and closes the lower end of the casing 12. The lower end plate 20 therefore defines a closure for the casing 12 that can be opened to allow the separator 10 to be emptied.

The lower end plate 20 is penetrated by a straight, open-ended tube defining an inlet duct 30 that defines an inlet to the separator 10. The inlet duct 30 has an axis defining an inlet axis that is parallel to the central axis 14 of the separator 10.

A portion of the inlet duct 30 extending inside the casing defines an inlet spout 32, an open upper end of which defines a spout outlet 34 through which air and entrained debris enters the primary bin 24. The inlet spout 34 is positioned to extend directly adjacent to the dividing wall 22. When installed in the device, a portion of the inlet duct 30 that is external of the casing 12 is connected to ducting within the device through which a flow of air to be filtered is pumped into the separator 10.

Accordingly, in this example the inlet and the outlet of the separator 10 are disposed at opposed longitudinal ends of the casing 12 and have parallel axes that are mutually spaced in a radial direction with respect to the central axis 14. It is noted that embodiments of the invention may be implemented in separators having other topologies, however.

The separator assembly 10 further includes a mesh 36 within the casing 12 that is mounted to, and effectively forms part of, the dividing wall 22 that separates the primary bin 24 from the secondary bin 26. The mesh 36 is generally oblong in front view, being taller than it is wide, and is shaped to conform to the shape of the dividing wall 22 and thus is curved in this example. The mesh 36 may be planar in other examples. Thus, the mesh 36 defines part of a boundary between the primary bin 24 and the secondary bin 26, and permits fluid flow between the primary bin 24 and the secondary bin 26.

The mesh 36 extends parallel to the central axis of the separator 10 and therefore vertically in this example. An end of the mesh 36 closest to the lower end of the housing defines a base of the mesh 36, and correspondingly a top of the mesh 36 is defined at the end of the mesh 36 closest to the upper end of the housing. It is noted, however, that in other variants the mesh 36 may be mounted in different ways and may be at any orientation with respect to the central axis 14. The mesh may also have a different shape.

The mesh 36 is positioned such that the base of the mesh 36 is adjacent to and directly above the spout outlet 34.

The mesh 36 is a porous screen defining a filter screen, and may have a pore size in the range of 100-500 microns, for example. The pores may have various shapes, including circular, oval or polygonal pores, for example. Rectangular pores, where used, may be oriented perpendicular to the incoming flow direction. The mesh 36 may be formed of plastic, or from metal with the pores being chemically-etched or electro-formed, for example.

Air in the primary bin 24 must pass through the mesh 36 to reach the secondary bin 26 and the outlet duct 28, such that the secondary bin 26 defines a downstream chamber of the separator 10. The mesh 36 prevents particles of a certain size from passing into the secondary bin 26, so that such particles accumulate in the primary bin 24. In this way, the primary bin 24 acts as a separating volume and the secondary bin 26 acts as an outlet volume.

In operation, an inlet air flow is drawn into the separator 10 through the inlet duct 30 by suction induced by a vacuum motor (not shown) of the device. The motor is disposed downstream of the outlet of the separator 10, and therefore applies suction to the outlet duct 28 to create the air flow through the separator 10. Air exiting the inlet spout 32 through the spout outlet 34 is admitted into the primary bin 24 immediately below the base of the mesh 36. The air continues on its initial path and thus flows generally vertically and hence across the mesh 36.

The lower pressure in the secondary bin 26 relative to the primary bin 24 defines a pressure differential across the mesh 36. Accordingly, as air flows across the mesh 36 a portion of the flow is drawn through the mesh 36 due to the pressure differential. Only air and particles that are smaller than the pores of the mesh 36 can pass through the mesh 36 to flow into the secondary bin 26 and on towards the outlet of the separator 10.

The remaining portion of the flow remains in the primary bin 24 and so establishes a circulatory secondary flow inside the primary bin 24 that acts to separate larger and/or heavier debris, whose momentum and weight precludes such particles being carried upwardly back towards the mesh 36, therefore causing such debris to be deposited and accumulate at the bottom of the primary bin 24. Smaller and/or lighter debris such as fluff and fibres also accumulate at the bottom of the primary bin 24, and in turn accumulated fluff and fibre can help to catch dust circulating in the secondary flow. The change in speed of the flow as it turns at the bottom of the primary bin 24 further promotes depositing of debris. Although not shown in the figures, baffles and other flow guides may be included to promote depositing of particles at the bottom of the primary bin 24.

Meanwhile, lighter particles that may continue to circulate with the secondary flow to return to the mesh 36 are deterred from attaching to the mesh 36 by the continuous flow across the mesh 36 from the inlet spout 34.

It follows from the above that, at each point on the mesh 36, a portion of an incident air flow continues across the mesh 36 and another portion of the flow is siphoned off and drawn through the mesh 36 due to the pressure differential across the mesh 36. As noted above, these flows are referred to as the ‘tangential flow’ and the ‘normal flow’ respectively, and the ratio of the normal flow to the tangential flow defines a ‘flow ratio’.

FIG. 1 shows three pairs of arrows at vertically spaced positions adjacent to the mesh 36, each pair representing the normal and tangential flow at those positions. For each pair of arrows, the tangential flow is represented by a straight arrow to the left and the normal flow is represented by a curved arrow to the right. The thickness of the arrow represents the magnitude of the corresponding flow, which shows that the tangential flow decreases moving upwardly, whereas the normal flow increases. It follows that the flow ratio increases moving upwardly.

A curved line to the right of the mesh 36 in FIG. 1 represents the profile of the normal flow entering the secondary bin 26, showing that the normal flow is significantly greater at the top of the mesh 36 than at the base, and increases non-linearly moving upwards.

The normal flow for a given portion of the mesh 36 is influenced by the local pressure differential across the mesh 36. This, in turn, is in part determined by the pressure profile in the secondary bin 26, which is not uniform. To the contrary, a significant pressure gradient may develop between the lower end of the secondary bin 26 and the outlet duct 28, largely due to the greater fluid velocity in the secondary bin 26 closer to the outlet duct 28. Meanwhile, the pressure in the primary bin 24 is typically more uniform, albeit still varied to some extent. This gives rise to a higher pressure differential across the mesh 36 at the top of the mesh 36, which is closest to the outlet and to the motor, than at the base of the mesh 36. This variation in the pressure differential tends to increase the normal flow at the top of the mesh 36 relative to at the base of the mesh 36, which in turn tends to increase the flow ratio.

Conversely, the tangential flow is lower at the top of the mesh 36 than at the base, which is partly due to the increase in the normal flow and also due to some of the flow having been drawn through the mesh 36 before reaching the top of the mesh 36, so that the overall flow is depleted at the top of the mesh 36.

In general terms, an increase in the normal flow promotes increased blinding of the mesh 36, since the normal flow acts to carry particles and debris into the mesh 36. Conversely, the tangential flow provides a washing effect that helps to keep the mesh 36 clear of particles, and so an increase in the tangential flow tends to decrease mesh blinding.

It follows that the rate at which the mesh 36 blinds is related to the flow ratio, with a higher flow ratio typically leading to a higher rate of blinding, all else being equal. Since the flow ratio varies across the mesh 36, it also follows that the mesh 36 will block more quickly in some regions, namely where the flow ratio is highest. Conversely, in regions of the mesh 36 where the flow ratio is below a certain level, the tangential flow may be capable of keeping that region of the mesh 36 clear over an extended period, and potentially even until the primary bin 24 is full.

Once an area of the mesh 36 blocks such that flow through that part of the mesh 36 ceases, a portion of the mesh 36 adjacent to the blocked portion may then become the portion with the highest flow ratio and so begin to block. In this way, the localised blinding effect may cause adjacent portions of the mesh 36 to block in succession relatively quickly, from the top of the mesh 36 downwards in the example of FIG. 1, such that performance of the device diminishes to the point where intervention is required to clean the mesh 36.

Recognising this, embodiments of the invention provide means for balancing the normal and tangential flow in each part of the mesh 36, so that the flow ratio becomes more uniform across the mesh 36. In this way, localised blinding of the mesh 36 can be reduced and separating performance can be improved, and the flow ratio is sufficiently low in all areas of the mesh 36 to resist blinding.

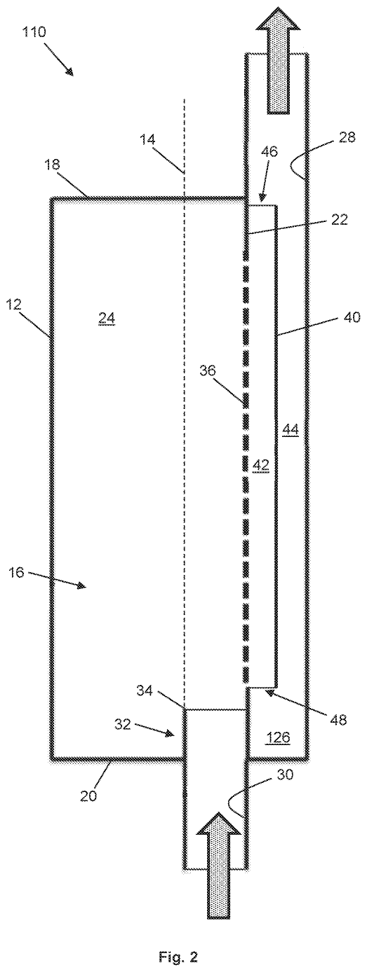

FIG. 2 shows a first example of a separator 110 that is adapted to balance the flow ratio across a mesh 36. The separator 110 shown in FIG. 2 is identical to that of FIG. 1 in most respects, and so only the differences shall be described.

In this respect, the separator 110 of FIG. 2 has a secondary bin 126 that is modified to manipulate the pressure distribution relative to the secondary bin 26 of the separator 10 of FIG. 1. In the example shown in FIG. 2, a modified pressure distribution in the secondary bin 126 is achieved by means of a partition wall 40 that is positioned in the secondary bin 126 to divide the secondary bin 126 into a high pressure zone 42 and a low pressure zone 44. In this respect, pressure in the high pressure zone 42 is generally higher than in the low pressure zone 44. It is noted, however, the pressure is not uniform in either zone 42, 44, and that pressure transitions arise at borders between the zones 42, 44.

The partition wall 40 extends parallel to the mesh 36 and is shaped in a similar manner to the mesh 36, and so is curved in this example. The partition wall is positioned approximately centrally in the secondary bin 126, extending from one side of the secondary bin 126 to the other in a direction orthogonal to the orientation shown in FIG. 2. The side edges of the partition wall 40 seal against the wall of the secondary bin 26 on each side of the secondary bin 26 to create an elongate, open-ended enclosed passage of uniform cross-section that occupies a space to the left of the partition wall 40 in FIG. 2, which passage extends vertically beside the mesh 36. The mesh 36 therefore forms part of a boundary wall of the passage.

A first opening 46 defines an exit from an upper end of the passage, the first opening 46 being formed between an upper edge of the partition wall 40 and the dividing wall 22 and therefore being located in the vicinity of the upper end of the mesh 36. The first opening 46 extends in a horizontal plane that coincides with the upper end of the partition wall 40, as viewed in FIG. 2. Correspondingly, a second opening 48 defines an exit from the lower end of the passage and is formed between a lower edge of the partition wall 40 and the dividing wall 22, in the vicinity of the base of the mesh 36, the second opening 48 extending in a horizontal plane that coincides with the lower end of the partition wall 40.

The partition wall 40 is taller than the mesh 36 and extends upwardly beyond the upper end of the mesh 36 and downwardly beyond the base of the mesh 36. Accordingly, the passage formed by the partition wall 40 encompasses the entire downstream surface of the mesh 36, namely the side of the mesh 36 that is in the secondary bin 126.

The high pressure zone 42 is defined by the volume contained within the passage created by the partition wall 40, and so is disposed between the partition wall 40 and the mesh 36. The first opening 46 represents an upper boundary of the high pressure zone 42, and the second opening 48 represents a lower boundary of the high pressure zone 42.

The remaining regions of the secondary bin 126 outside the high pressure zone 42 define the low pressure zone 44. Accordingly, the low pressure zone 44 includes the outlet of the separator 110 and is in direct fluid communication with the outlet duct 28. Notably, the low pressure zone 44 extends around both ends of the high pressure zone 42 and so envelops the high pressure zone 42. Each of the first and second openings 46, 48 therefore communicates directly with the low pressure zone 44.

The high and low pressure zones 42, 44 are mutually isolated by the partition wall 40, apart from through the first and second openings 46, 48, which create fluid communication between the high pressure zone 42 and the low pressure zone 44.

As noted above, in the example shown in FIG. 1 a significant pressure gradient arises in the secondary bin 26 when the device operates. The partition wall 40 of the separator 110 shown in FIG. 2 mitigates this, by acting to translate the low pressure from the outlet end of the secondary bin 26 to the part of the secondary bun 26 closer to the inlet. The portion of the secondary bin 126 behind the partition wall 40 is therefore protected from a pressure rise caused by the flow through the mesh 36.

Accordingly, the pressure in the low pressure zone 44 is more uniform than in the secondary bin 26 of the separator 10 of FIG. 1, and so the partition wall 40 effectively acts to equalise pressure between the first and second openings 46, 48, relative to the situation if the partition wall 40 were absent, so that the pressure at the first opening 46 is the same as, or similar to, the pressure at the second opening 48. Thus, similar levels of suction are generated at the base of the mesh 36 as at the top of the mesh 36, which in turn promotes a higher normal flow in lower regions of the mesh 36 than for the example of FIG. 1.

Conversely, the shape and size of the high pressure zone 42 means that the flow through the mesh 36 is constrained once it enters the secondary bin 126, so that pressure is relatively high, and relatively uniform, throughout the high pressure zone 42.

More generally, the partition wall 40 defines openings between different pressure zones that are at different distances from the outlet, and adjacent to respective portions of the mesh 36 that are at similarly different distances from the outlet, and yet are at a similar pressure. The partition wall 40 therefore effectively breaks a link between the distance that a point on the mesh is from the outlet and the suction that the portion is exposed to in operation.

In this way, the partition wall 40 may be regarded as effectively creating a pressure short circuit that extends low pressure from the top of the mesh 36 down to the base of the mesh 36, and thereby balances the flow through the mesh 36 such that the flow ratio becomes more uniform across the mesh 36. In turn, localised accelerated blinding of the mesh 36 as a result of a particularly high flow ratio is mitigated.

Although the wall thickness of the partition wall 40 reduces the cross sectional area of the secondary bin 126 and therefore creates a slight flow restriction, this is more than compensated by the effect of the partition wall 40 to reduce mesh blinding.

A related effect of the partition wall 40 is to create multiple flow paths within the secondary bin 26 along which air passing through the mesh 36 may travel to reach the outlet. Specifically, a first flow path extends from the high pressure zone 42 to the outlet through the first opening 46, while a second flow path extends from the high pressure zone 42 to the outlet through the second opening 48. The second flow path therefore passes through the portion of the low pressure zone 44 that extends beside the partition wall 40. In contrast, in the arrangement of FIG. 1 all air passing through the mesh 36 flows along substantially the same path towards the outlet, meaning that air passing through lower portions of the mesh 36 is obstructed by air passing through upper regions of the mesh 36. The partition wall 40 relieves this situation by enabling air passing through the lower end of the mesh 36 to bypass the upper portion of the mesh 36 by flowing along the second flow path.

It is noted that, in practice, there will be a transition in pressure between the high and low pressure zones 42, 44 at each of the first and second openings 46, 48, although these transitions are sufficiently short that each transition may be approximated as a step change in pressure for the purposes of this description.

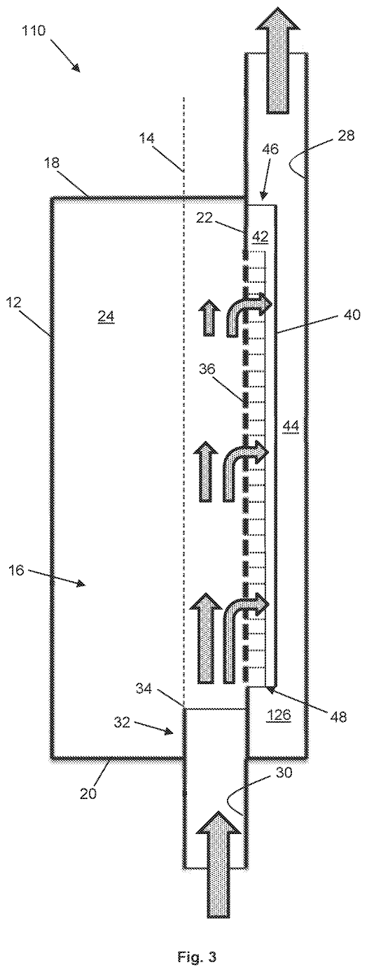

The effect of the partition wall 40 to translate low pressure to the region of the base of the mesh 36 is illustrated in FIG. 3, which shows the same separator 110 as FIG. 2 but represents the profile of the flow through the mesh 36. Whereas this profile is curved and uneven in FIG. 1 where the partition wall 40 is absent, in FIG. 3 the profile is uniform along the entire mesh 36, meaning that the normal flow is substantially uniform through all parts of the mesh 36.

FIG. 3 also shows three pairs of arrows corresponding to those in FIG. 1 to represent the normal and tangential flow at three different vertical levels. Unlike the example of FIG. 1, in FIG. 3 the arrows representing the normal flow are all of similar thickness, emphasising the effect of the partition wall 40 to spread the flow across the mesh 36.

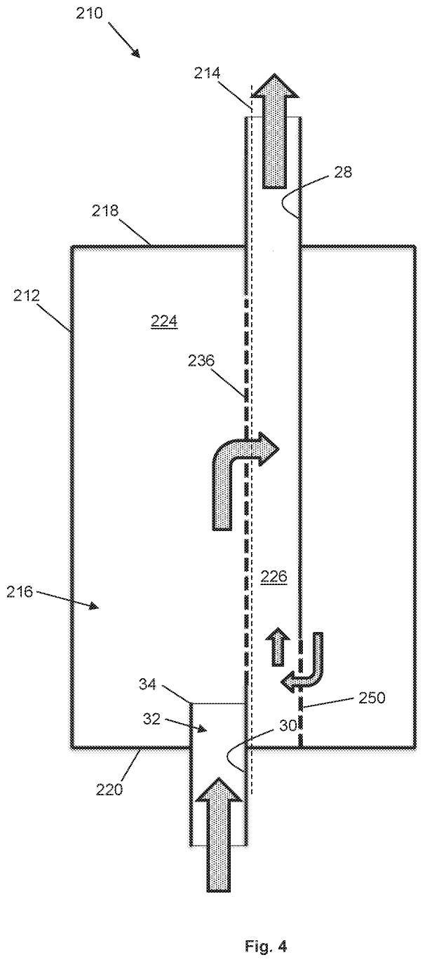

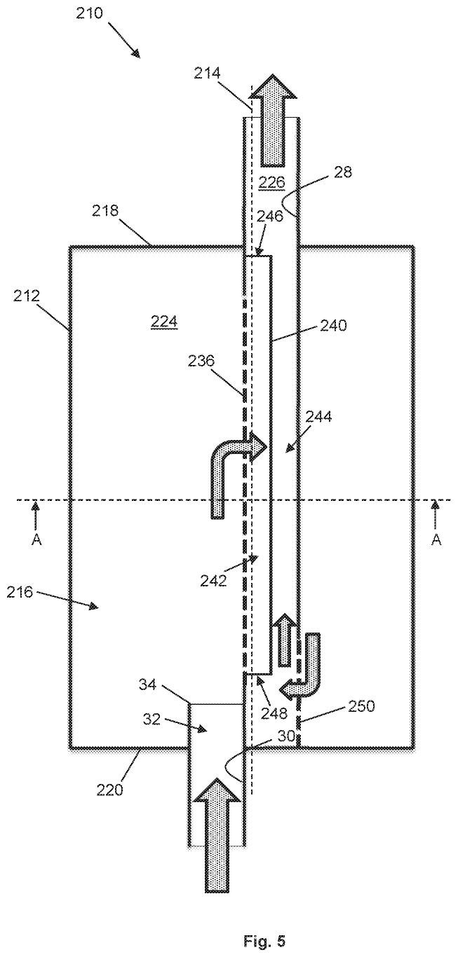

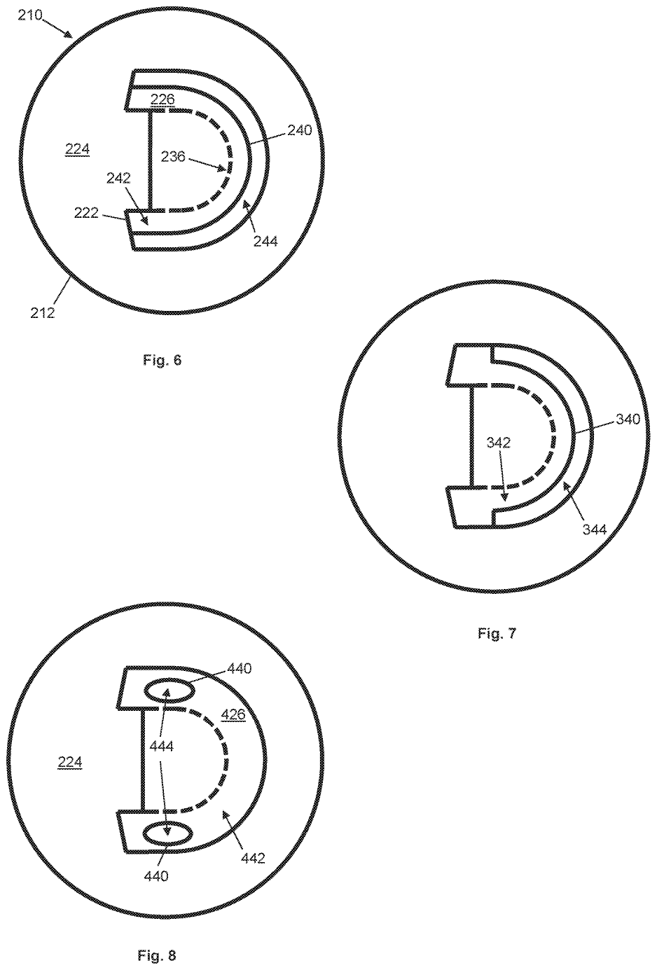

FIGS. 4 to 6 show another example of a separator 210 to which principles of the invention may be applied. FIG. 4 shows the separator 210 without a partition wall, while FIGS. 5 and 6 show the separator 210 with a partition wall 240. The separator 210 is similar to that of FIG. 1 in most respects, and so some details are omitted in the interests of clarity.

Like the separator 10 shown in FIG. 1, the separator 210 of FIG. 4 comprises a casing 212 defined by a tubular wall of circular cross section. The wall of the casing 212 encircles a central axis 214 to enclose a cylindrical interior volume 216, the central axis 214 also defining a central longitudinal axis of the separator 210. An upper end of the casing 212 receives and is closed by an upper separator assembly represented by an upper end plate 218 in the simplified view of FIG. 4, and correspondingly the lower end of the casing 212 is closed by a lower separator assembly represented by a lower end plate 220. The casing 212, the upper end plate 218 and the lower end plate 220 therefore collectively define a housing of the separator 10 that contains the interior volume 216.

The lower end plate 220 is penetrated by a straight, open-ended tube defining an inlet duct 30 that defines an inlet to the separator 10, a portion of the inlet duct 30 extending inside the casing 212 defining an inlet spout 32 having a spout outlet 34 at its tip.

In this example, a secondary bin 226 is defined by an enclosed channel defined by a dividing wall 222 that forms a closed loop, the channel extending vertically through the interior volume 216 of the casing 212, so that the secondary bin 226 partially encircles the central axis 214. The shape of the secondary bin 226 is shown more clearly in FIG. 6, and is described below. The secondary bin 226 is surrounded by a portion of the interior volume 216 defining a primary bin 224, the primary bin 224 having the general form of an annulus having an opening corresponding to the secondary bin 226. The secondary bin 226 is therefore encircled by the primary bin 224 in this example. The dividing wall 222 containing the secondary bin 226 engages and forms a fluid seal with the lower end plate 220 at one end, and extends through the upper end plate at the other end to define an outlet duct 28.

The separator 210 of FIG. 4 incorporates two meshes through which fluid may flow between the primary bin 224 and the secondary bin 226, both of which meshes are incorporated into the wall of the tube defining the secondary bin 226. Aside from the fluid communication provided through the meshes, the primary bin 224 and the secondary bin 226 are otherwise mutually isolated.

A first mesh 236 is disposed on a left side of the secondary bin 226, as viewed in FIG. 4, and is generally similar in size, position and structure to the mesh 36 of the examples of FIGS. 1 and 2. A second mesh 250 that is smaller than the first mesh 236 is disposed on the opposite side of, and at a lower end of, the secondary bin 226.

The first mesh 236 defines a primary mesh through which a majority of an overall flow into the secondary bin 226 enters the secondary bin 226. The second mesh 250 defines an auxiliary mesh through which a smaller portion of the overall flow into the secondary bin 226 flows. For example, the separator 210 may be configured such that approximately 90% of the overall flow from the primary bin 224 to the secondary bin 226 flows through the primary mesh 236, as represented by the respective thicknesses of arrows indicating the flow through each mesh 236, 250.

By creating an additional connection between the primary bin 224 and the secondary bin 226, the auxiliary mesh 250 adds another area of suction to the primary bin 224. This, in turn, manipulates the flow and pressure distribution within the primary bin 224 and hence enhances control over how debris accumulates in the primary bin 224.

FIGS. 5 and 6 show the effect of incorporating a partition wall 240 into the separator 210 of FIG. 4.

FIG. 6 shows a transverse cross-section of the separator 210, which reveals that the secondary bin 226 is U-shaped in this example, in that it has a generally horseshoe shape. This horseshoe shape is defined by the closed loop formed by the dividing wall 222 that separates the secondary bin 226 from the primary bin 224. The dividing wall 222 has inner and outer concentric curved portions, each curved portion having straight portions at each end that are connected by short, generally radial portions to complete the loop. Each curved portion of the dividing wall 222 may be regarded as defining a partial tube that is substantially concentric with the wall of the casing 212.

As in the previous example, the primary mesh 236 is shaped to conform to the shape of the part of the dividing wall 222 in which it is incorporated, and thus has corresponding curvature to that of the dividing wall 222. Although the auxiliary mesh 250 is not visible in FIG. 6, it also has curvature corresponding to that of the dividing wall 222.

As in the example of FIG. 2, the partition wall 240 is disposed centrally in the secondary bin 226 and extends parallel to the primary mesh 236, thereby dividing the secondary bin 226 into a high pressure zone 242 and a low pressure zone 244. FIG. 6 shows that the partition wall 240 has a horseshoe shape corresponding to the shape of the dividing wall 222 in this example, and extends from one side of the secondary bin 226 to the other, to seal against the generally radial portions of the dividing wall 222.

The partition wall 240 creates an enclosed passage that encompasses the primary mesh 236 and has a first opening 246 at its upper end and a second opening 248 at its lower end. Fluid within the high pressure zone 242 can flow to the low pressure zone 244 only through the first opening 246 or the second opening 248. As in the earlier example, this has the effect of equalising pressure at the first and second openings 246, 248 and thereby increasing suction near the base of the primary mesh 236, which balances flow over the primary mesh 236.

However, the partition wall 240 has a further effect in the separator 210 of FIGS. 4 and 5, in that the additional suction that is generated in the lower portion of the secondary bin 226 also acts to draw a higher flow through the auxiliary mesh 250, in turn reducing the flow through the primary mesh 236. This is shown by the change in the thicknesses of the arrows showing the flow through each mesh 236, 250. In this example, the effect of the partition wall 240 reduces the flow through the primary mesh 236 to 80% of the total flow passing through the separator 210.

Accordingly, the partition wall 240 also acts to alter the split of the flow within the primary bin 224 between the primary and auxiliary meshes 236, 250, and so provides an additional means for controlling flow within the primary bin 224 and through the meshes 236, 250. This may be useful, for example, to avoid the primary mesh 236 blocking at a faster rate than the auxiliary mesh 250.

FIGS. 7 and 8 show variants of the separator 210 of FIGS. 4 to 6 having different partition wall configurations.

In FIG. 7, the partition wall 340 has a similar shape to that shown in FIG. 6, but does not extend the entire way around the secondary bin 226 and does not reach the radial portions of the dividing wall 222. Instead, the partition wall 340 includes outwardly-extending radial portions that are coplanar in a plane that intersects the central axis 214. This shaping of the partition wall 340 has the effect of increasing the volume of the high pressure zone 342 and creating a corresponding decrease in the volume of the low pressure zone 344, which may enhance performance in certain applications.

In the variant shown in FIG. 8, the single partition wall of the earlier examples is replaced by a pair of separate partition walls 440 that each form distinct tubes that extend generally parallel to the central axis 214, albeit squashed tubes with an oval cross-section in this example. Each of the tubes defined by the partition walls 440 defines a respective first opening at an upper end of the tube, and a corresponding second opening at a lower end of the tube. Thus, the tubes defined by the partition walls 440 provide a similar effect of translating low pressure from an area near the outlet of the separator 210 to a region towards the lower end of the secondary bin 426 and thus increase suction at the lower end of the primary mesh 236. Accordingly, in this example a low pressure zone 444 of the secondary bin 426 includes the space inside the tubes, while the space around the tubes and up to the level of the respective first openings of the tubes defines a high pressure zone 442.

It should be appreciated that the tubes defined by the partition walls may be sized, shaped and positioned differently to the manner shown in FIG. 8, and the number of tubes used may vary in other examples. The tubes may also be of varying height so that the respective second openings are staggered vertically according to the orientation shown in FIGS. 4 to 6, to translate suction to different vertical levels of the secondary bin 226.

More generally, various shapes and configurations are possible for partition walls that divide a secondary bin, or outlet volume, into one or more high pressure zones and one or more low pressure zones, with openings at different distances from an outlet of the separator providing fluid communication between the different zones.

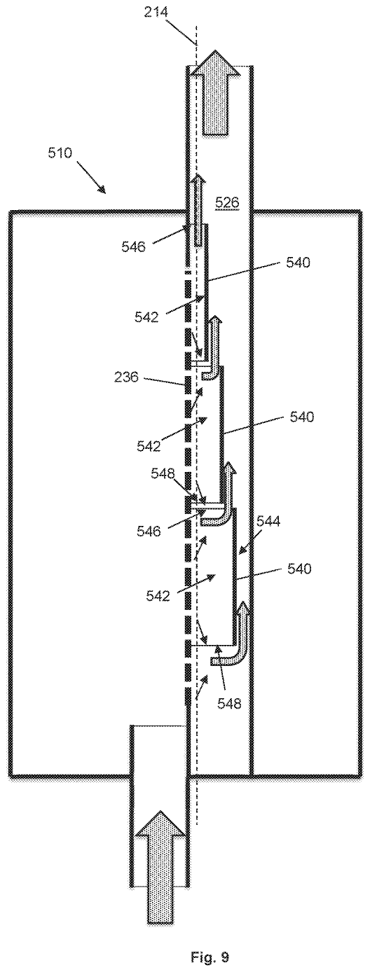

Another variant of a separator 510 is shown in FIG. 9. This separator 510 is substantially identical to that of FIGS. 4 to 6, except the auxiliary mesh is omitted and the single partition wall shown in FIG. 5 is replaced by a series of three separate partition walls 540. The partition walls 540 are coaxial, or mutually parallel if planar, and are arranged in a vertically and radially staggered formation, the uppermost partition wall 540 being positioned with the smallest radial spacing from the mesh 236.

Each partition wall 540 defines a respective first opening 546 at its upper end and a respective lower opening 548 at its lower end. High pressure zones 542 are created within the space enclosed by each partition wall 540, between the respective first and second openings 546, 548, while the remaining space within the secondary bin 526 defines a low pressure zone 544.

The staggering of the partition walls 540 therefore creates a vertical series of openings between the low pressure zone and the high pressure zones adjacent to the mesh 236, which openings are all at a similar low pressure. Accordingly, the openings create corresponding vertically spaced regions of enhanced suction adjacent to the mesh 236, which may enhance manipulation of pressure in the secondary bin 526 to balance flow through the mesh 236.

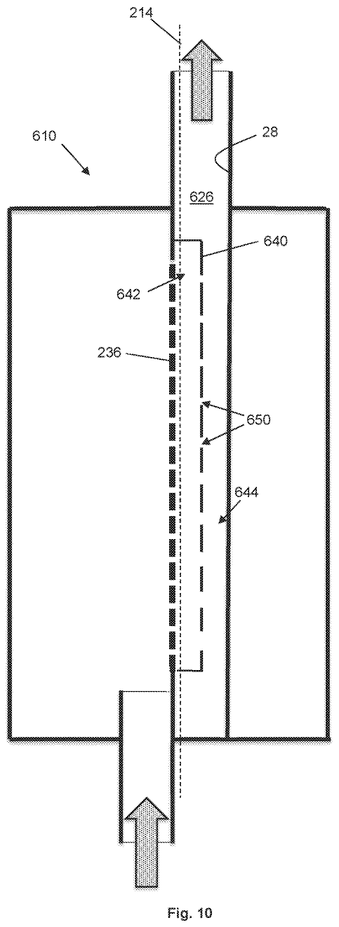

Turning finally to FIG. 10, a separator 610 representing a further variant of the separator of FIGS. 4 to 6 is shown. Again, the auxiliary mesh is omitted. In this variant, the continuous partition wall shown in FIG. 5 is replaced by a perforated partition wall 640, which includes a vertical series of perforations 650 that define openings between a high pressure zone 642 enclosed by the partition wall 640 and containing the downstream side of the mesh 236, and a low pressure zone 644 that leads to and includes the outlet duct 28.

As the partition wall 640 is parallel to the central axis 214, the perforations 650 are spaced along an axis that is parallel to the central axis 214, and that is coaxial with the outlet axis in this example. Accordingly, the perforations 650 are at different distances from the outlet duct 28 and so they create a series of points at which similar levels of suction are generated, in a similar way to the openings defined at the opposed ends of the passages formed by the partition walls of the examples described above.

It is noted that the partition wall 640 may include further perforations that are spaced from those visible in FIG. 10 in a direction orthogonal to the plane of the image. For example, the partition wall 640 could include a two dimensional array of perforations 650.

The partition wall 640 also includes upper and lower radially-extending end portions that close the upper and lower ends of the passage created by the partition wall 640, such that fluid communication between the high pressure zone 642 and the low pressure zone 644 is provided exclusively through the perforations 650 formed in the partition wall 640. Accordingly, openings into the low pressure zone 644 from the high pressure zone 642 are defined by the openings formed in the partition wall itself in this example, namely the perforations 650. However, it is also possible for the partition wall to be open at its upper and lower ends to provide the same first and second openings as in the FIG. 5 example, in addition to the openings provided by the perforations, so that the ends of the passage defined by the partition wall also define additional openings into a low pressure zone from a high pressure zone.

In the example shown in FIG. 10, the perforations 650 become progressively larger with distance from the outlet duct 28. The perforations 650 also become closer together with distance from the outlet duct 28. Configuring the perforations 650 in this way may account for changes in fluid pressure and velocity within the secondary bin 626 to create even levels of suction across the mesh 236. In principle, however, a partition wall may be perforated in various ways to distribute suction throughout a secondary bin.

It will be appreciated that various changes and modifications are possible within the scope of the invention.

For example, a partition wall may be inclined relative to a central axis of a separator and/or relative to the mesh beside which the wall extends.

1. A separator for a fluid cleaning device, the separator comprising:
a separating volume;
an inlet through which a fluid flow containing entrained debris flows into the separating volume, in use;
an outlet through which a filtered fluid flow is discharged from the separator, in use;
a filter screen configured to retain the debris in the separating volume while allowing fluid to exit the separating volume to form the filtered fluid flow;
an outlet volume disposed between the separating volume and the outlet, the outlet volume being configured to receive the filtered fluid flow from the separating volume through the filter screen; and
a partition wall that partitions the outlet volume into a high pressure zone and a low pressure zone, wherein the partition wall defines first and second openings into the low pressure zone from the high pressure zone, the first and second openings being at different distances from the outlet.

2. The separator of claim 1, wherein the partition wall extends parallel to the filter screen.

3. The separator of claim wherein the partition wall defines an open-ended enclosed passage defining the high pressure zone.

4. The separator of claim 3, wherein the filter screen defines part of a boundary of the passage.

5. The separator of claim 3 or claim 4, wherein the first and second openings are disposed at opposed ends of the passage.

6. The separator of claim 3, wherein the passage has a uniform cross-section along its length.

7. The separator of claim 1, comprising multiple partition walls.

8. The separator of claim 1, wherein at least one of the first and second openings is defined between the partition wall and another wall of the separator.

9. The separator of claim 8, wherein at least one of the first and second openings is defined between the partition wall and a wall of the separating volume.

10. The separator of claim 1, wherein at least one of the first and second openings is formed in the partition wall.

11. The separator of claim 10, wherein the partition wall comprises the first opening and the second opening, wherein the second opening is further from the outlet than the first opening, and wherein the second opening is larger than the first opening.

12. The separator of claim 1, wherein the first opening is disposed between the second opening and the outlet.

13. The separator of claim 1, wherein the filter screen is curved.

14. The separator of claim 1, wherein a cross section of the partition wall defines a closed loop so that the partition wall forms a tube or channel.

15. The separator of claim 1, wherein the inlet and the outlet are spaced along a longitudinal axis of the separator.

16. The separator of claim 15, wherein the inlet and the outlet are disposed at opposed longitudinal ends of the separator.

17. The separator of claim 1, comprising multiple filter screens through which fluid flows from the separating volume into the outlet volume.

18. The separator of claim 1, comprising a housing that contains the separating volume and the outlet volume.

19. A cleaning device comprising the separator of claim 1.

20. A method of configuring a separator for a fluid cleaning device, the method comprising partitioning an outlet volume of the separator into a high pressure zone and a low pressure zone, so that first and second openings into the low pressure zone from the high pressure zone are at different distances from an outlet of the separator.
